(19) United States
(12) Patent Application Publication
(10) Pub. No.: US 2006/0255208 A1
(43) Pub. Date: Nov. 16, 2006

(54) Multipurpose winglet for aircraft

(76) Inventor: Thomas Hawkins, Mountain View, CA (US)

Correspondence Address: Mark Terry, 2250 SW 3rd Av. Ste. 500, Miami, FL, 33129, US

(21) Appl. No.: 11/355,574

(22) Filed: Feb. 16, 2006

Related U.S. Application Data
(60) Provisional application No. 60/653,911, filed on Feb. 16, 2005.

(51) Int. Cl. B64C 35/00

(52) U.S. Cl. 244/105

(57) ABSTRACT

A component for a hull-type seaplane is disclosed. The component includes a first sponson-shaped element that provides buoyancy in water. The component further includes a first planar element coupled on one end with the first sponson-shaped element and coupled on another end to a hull on one side of the seaplane, wherein the first planar element allows a passenger to stand on it. In one alternative, the component further comprises a second sponson-shaped element that provides buoyancy in water and a second planar element coupled on one end with the second sponson-shaped element and coupled on another end to the hull on another side of the seaplane, wherein the second planar element allows a passenger to stand on it.

### CROSS-REFERENCE TO RELATED APPLICATIONS

The present patent application claims priority to U.S. provisional patent application Ser. No. 60/653,911 filed on Feb. 16, 2005 and entitled “Multipurpose Winglets on a Seaplane.” U.S. provisional patent application Ser. No. 60/653,911 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of aircraft design and more particularly relates to the field of design features for seaplanes.

### BACKGROUND OF THE INVENTION

The Federal Aviation Administration (FAA) recently instituted a new aircraft certification for Light-Sport Aircraft. Section 1.1 of title 14 of the Code of Federal Regulations (CFR) puts forth the details of the new certification. Light-sport aircraft are simple, low-performance aircraft that are limited to 1,320 lbs. maximum weight, two occupants, a single non-turbine powered engine, stall speed of 45 knots, maximum airspeed of 120 knots, and fixed landing gear. Aircraft categories include airplanes, weight-shift-control aircraft, powered parachutes, gyroplanes, gliders, balloons and airships.

The FAA further instituted a new airworthiness certificate entitled Special Light-Sport Airworthiness Certificate. The details of this certificate are defined in section 21.190 of title 14 of the Code of Federal Regulations. This new category of special airworthiness certificate is issued to aircraft that are designed and manufactured to an identified standard developed by industry and accepted by the FAA. These aircraft can be used for the following purposes: sport and recreation, flight training, rental and towing.

With regard to certification of pilots and flight instructors to operate light-sport aircraft, the FAA also recently created two new pilot certificates and two new aircraft category ratings to allow operations of light-sport aircraft. The sport pilot certificate and flight instructor certificate with a sport pilot rating are issued without any category and class ratings. Aircraft category, class, and make and model privileges are established through logbook endorsements.

The purpose behind the new FAA certifications is to introduce lightweight recreational aircraft that are geared toward the recreational pilot. It is predicted that this development will result in the spawning of a new industry that services lightweight sport aircraft and recreational pilots. More aircrafts will be seen in the sky and more pilots will be flying. This new development, however, will not come without its drawbacks.

Almost as soon as the new aircraft and pilot certifications emerge, so will safety issues. As a result of the new aircraft certification and the predicted low cost of producing light sport aircraft, there will be more aircraft on the ground and in the air. This leads to traffic issues and problems related to restricting access to aircraft. As a result of the new pilot certifications, there will be more and lesser-trained pilots flying these aircraft in the skies. Further, there will be an increased number of novice pilots and their passengers near and around light sport aircraft on the ground. This increases the potential for accidents relating to the interaction between people and potentially dangerous aircraft. The potential for accidents is further compounded by the reduced experience required of the new pilot certification. Additionally, these new aircraft will appear in areas previously not accessible by aircraft like boat marinas, grass fields, etc.

One type of recreational aircraft is a seaplane or amphibious seaplane. Generally, seaplanes are small passenger planes that take off and land on water. Amphibians also have landing gear and can takeoff and land on both land and water. There are two types of conventional seaplanes: 1) floatplanes and 2) hull-type seaplanes. In floatplanes, a conventional aircraft is mounted onto external floats, otherwise known as pontoons. Only the floats of a floatplane rest in water when it is landed. In the hull-type, the actual aircraft fuselage is designed to rest directly in the water without the need for floats.

Each type of conventional seaplane has disadvantages. The disadvantage of floatplanes is the large amount of increased aerodynamic drag and weight caused by the floats and mounting structures. In hull-type seaplanes, the disadvantages are that, since the hull sits in the water, entry and exit to the aircraft must usually occur from the water or from a special dock build to accept these types of seaplanes. Additionally, hull-type seaplanes require buoyancy devices for lateral stability on the water. These devices are called sponsons and are mounted under the wings. The presence of the sponsons make docking and handling of a hull-type seaplane more difficult than that of a floatplane that can easily be moored next to a low dock or boat. One last disadvantage of a hull-type seaplane is that, unlike on a floatplane where the operator can stand outside the plane on the floats, an operator of a hull-type has little place to stand while using a paddle or attempting to maneuver while mooring the seaplane.

Therefore, a need exists to overcome the problems with the prior art as discussed above, and particularly for a way to introduce more safety and convenience features for aircraft, especially seaplanes.

### SUMMARY OF THE INVENTION

Briefly, according to an embodiment of the present invention, an apparatus for an aircraft is disclosed. The apparatus includes at least one member coupled to a fuselage of the aircraft, wherein the at least one member provides buoyancy in water and a planar element for allowing a passenger to stand on it. In one alternative, the at least one member has a cross-sectional airfoil shape and is positioned underneath an opening in the aircraft. In another alternative, the at least one member comprises two members, wherein each member is coupled to either side of the aircraft.

In another embodiment of the present invention, a component for a hull-type seaplane includes a first sponson-shaped element that provides buoyancy in water. The component further includes a first planar element coupled on one end with the first sponson-shaped element and coupled on another end to a hull on one side of the seaplane, wherein the first planar element allows a passenger to stand on it. In one alternative, the component further comprises a second sponson-shaped element that provides buoyancy in water and a second planar element coupled on one end with the second sponson-shaped element and coupled on another end to the hull on another side of the seaplane, wherein the second planar element allows a passenger to stand on it.

In another embodiment of the present invention, a hull-type seaplane includes a hull that rests in water when the seaplane is landed, a propeller engine and a fixed wing. The hull-type seaplane further includes a pair of sponsons, each sponson coupled to the hull on opposite sides of the seaplane. Each sponson includes a planar element coupled to the hull such that passengers may stand on it and an elongated ellipsoid-shaped member coupled to one end of the planar element, wherein the ellipsoid-shaped member rests within water when the seaplane is landed.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration showing a view of the right side of a light sport aircraft with a pair of sponsons, in one embodiment of the present invention.

FIG. 2 is an illustration showing a frontal view of the aircraft of FIG. 1.

FIG. 3 is an illustration showing various aerodynamic cross-sectional shapes for the propeller guard, in one embodiment of the present invention.

FIG. 4 is an illustration showing a top view of the aircraft of FIG. 1.

FIG. 5 is an illustration showing a right-side view of the aircraft of FIG. 1.

FIG. 6 is an illustration showing an angled view of the aircraft of FIG. 1.

### DETAILED DESCRIPTION

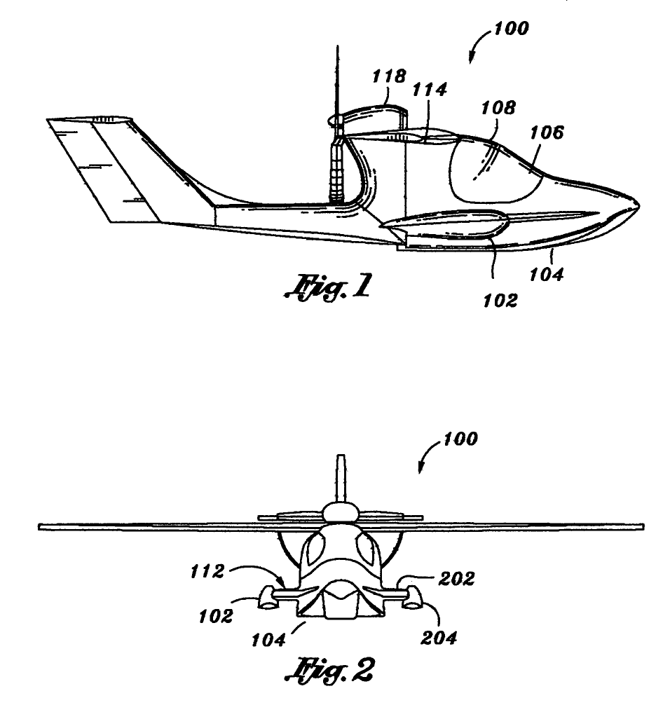

FIG. 1 is an illustration showing a view of the right side of a light sport aircraft 100 with a pair of sponsons, in one embodiment of the present invention. The aircraft 100 is a hull-type seaplane including a fixed wing 114 and a propeller 118 including propeller blades that rotate. The fuselage or hull 104 of the aircraft 100 is located under the fixed wing 114. FIG. 1 further shows an elongated, substantially ellipsoidal-shaped element 102 located on the right side of the aircraft 100. The substantially ellipsoidal-shaped element 102 acts like a sponson and is coupled to the hull 104 underneath an opening 106 in the aircraft. The opening 106 is used to allow for ingress and egress of passengers and pilot into and out of the aircraft 100. The opening 106 is covered with a canopy 108 that opens and closes to allow ingress and egress of passengers. Although not shown, an identical substantially ellipsoidal-shaped element is positioned on the opposite, left, side of the aircraft 100.

The ellipsoidal-shaped element 102 is buoyant in water (i.e., the amount of water displaced by the element 102 weighs more than the element 102) and may include a cavity that is filled with a gas, such as air, or a low density material such as foam or Styrofoam. The cavity may also be filled with air-filled enclosures. It should be noted that the present invention supports the positioning of the ellipsoidal-shaped element 102 anywhere on the hull 104, whether the ellipsoidal-shaped element 102 is positioned near the front, near the rear or near the center of the hull 104.

FIG. 1 shows the cross-sectional airfoil shape of the ellipsoidal-shaped element 102. FIG. 1 shows that the ellipsoidal-shaped element 102 possesses an aerodynamic or airfoil cross-sectional shape, also known as a teardrop shape. Such a shape adds aerodynamic properties to the ellipsoidal-shaped element 102, such as producing lift, reducing drag, or any combination of the two. An aerodynamic cross-sectional shape is not symmetrical so as to impose a certain force or property. In one embodiment of the present invention, the cross-sectional streamlined shape of the ellipsoidal-shaped element 102 is designed not to create lift but to reduce drag. FIG. 3 is an illustration showing various aerodynamic cross-sectional shapes for the ellipsoidal-shaped element 102, in one embodiment of the present invention.

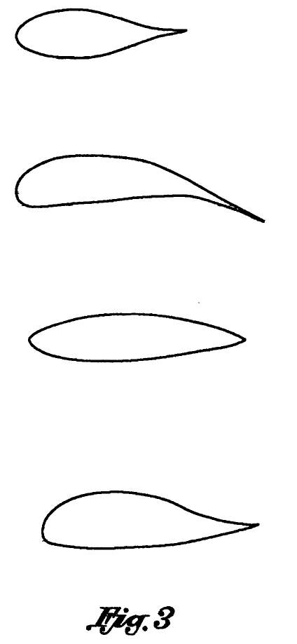

FIG. 2 is an illustration showing a frontal view of the aircraft 100 of FIG. 1. FIG. 2 shows the ellipsoidal-shaped element 102 connected to the right side of the hull 104 via a planar element 112. FIG. 2 also shows the ellipsoidal-shaped element 204 connected to the left side of the hull 104 via a planar element 202. The planar elements 112, 202 serve both to connect the respective ellipsoidal-shaped elements to the hull 104 and to provide a place for passengers to stand when entering or exiting the aircraft 100 via the opening 106.

The planar elements 112, 202 and the ellipsoidal-shaped elements 204, 102, like the other members of the aircraft 100, can be composed of a variety of materials, such as commonly used aerospace composite material, metal, carbon fiver, Kevlar, aluminum, titanium, alloy, common aircraft alloy, aluminum-steel alloy or titanium welded alloy.

The planar elements 112, 202 and the ellipsoidal-shaped elements 204, 102 can be molded composite members that are coupled together with a fastener such as one or more screws, nails, bolts or rivets. The planar elements 112, 202 and the ellipsoidal-shaped elements 204, 102 can also be coupled together with a liquid or semi-liquid glue or joint compound that dries after application. In another embodiment of the present invention, a joint is created between the planar elements 112, 202 and the ellipsoidal-shaped elements 204, 102 wherein a removable fastener secures the two members together. In yet another embodiment of the present invention, the planar elements 112, 202 and the ellipsoidal-shaped elements 204, 102 are molded or fabricated together as one integrated piece.

The planar elements 112, 202 can be molded composite members that are coupled to the hull 104 with a fastener. Further, the planar elements 112, 202 can also be coupled to the hull 104 with a liquid or semi-liquid glue or joint compound. In another embodiment of the present invention, a joint is created between the planar elements 112, 202 and the hull 104 wherein a removable fastener secures the two members together. In yet another embodiment of the present invention, the planar elements 112, 202 and the hull 104 are molded or fabricated together as one integrated piece.

FIG. 2 shows the cross-sectional airfoil shape of the planar elements 112, 202.

FIG. 2 shows that the planar elements 112, 202 possess an aerodynamic or airfoil cross-sectional shape, also known as a teardrop shape. In one embodiment of the present invention, the cross-sectional streamlined shape of the planar elements 112, 202 is designed not to create lift but to reduce drag. FIG. 3 is an illustration showing various aerodynamic cross-sectional shapes for the planar elements 112, 202, in one embodiment of the present invention.

In another embodiment of the present invention, the top surface of the planar elements 112, 202 extend over or on top of the respective ellipsoidal-shaped elements 204, 102. That is, the planar top surface of a planar element is continuous with a planar top surface of the corresponding ellipsoidal-shaped element. In this embodiment, the continuous surface of each planar element/ellipsoidal-shaped element combination provides a continuous, planar top surface that may be used by passengers to stand, sit or use for any other purpose.

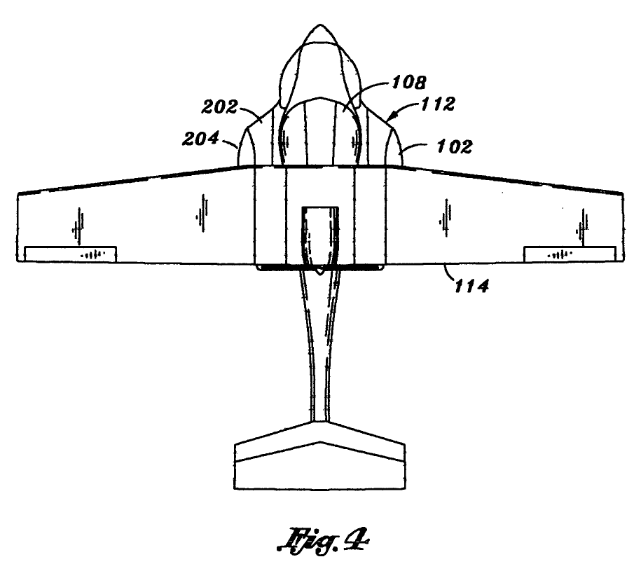

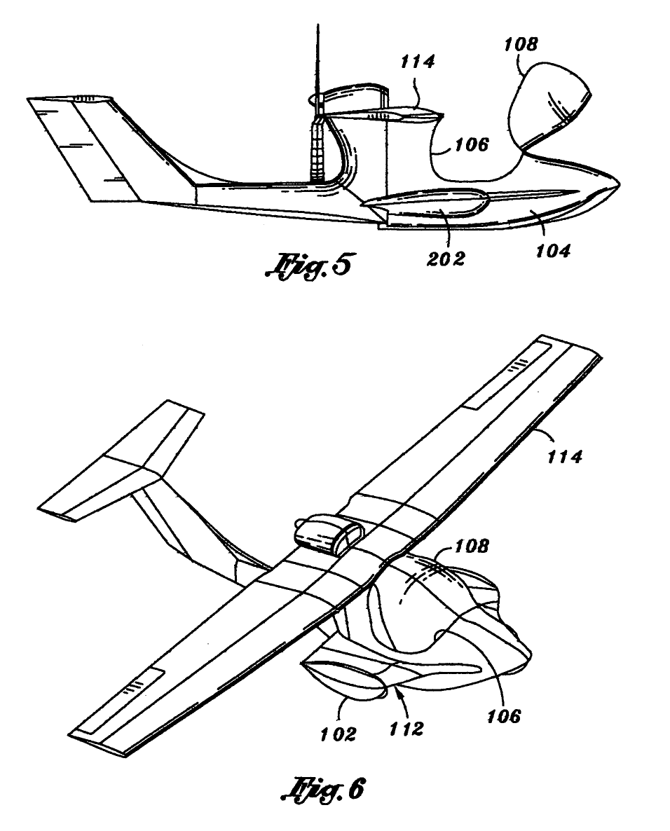

FIG. 4 is an illustration showing a top view of the aircraft of FIG. 1. FIG. 4 shows the fixed wing 114, the planar elements 112, 202 and the ellipsoidal-shaped elements 204, 102. FIG. 4 also shows the canopy 108 of the aircraft, allowing for ingress and egress of passengers into and out of the aircraft. FIG. 5 is an illustration showing a right-side view of the aircraft of FIG. 1. The aircraft of FIG. 5 is similar to the aircraft of FIG. 1 except that the aircraft of FIG. 5 shows the canopy 108 opened, allowing for ingress and egress of passengers into and out of the aircraft.

FIG. 6 is an illustration showing an angled view of the aircraft of FIG. 1. FIG. 6 shows the planar element 112 in greater detail. The planar element 112 provides a platform for passengers to access the opening 106 both on land and over water. This embodiment also provides a platform from which a swimmer or person in the water can access the aircraft or a person on the aircraft can easily access the water (e.g., similar to a platform on a rear of a ski boat). Note also that the planar element 112 (and the planar element 202) extends in front of the fixed wing 114, such that a passenger may stand upright on the planar element 112 (or the planar element 202) without being obstructed by the fixed wing 114.

In another embodiment of the present invention, one or more of the planar elements 112, 202 include a handle or other protrusion (not shown) that may be used by passengers to steady themselves when they enter or exit the aircraft from or into water. The handle or other protrusion may also be used to secure the aircraft to a dock or other vehicle using a rope or line. Further, the handle or other protrusion may be used to pull or otherwise maneuver the aircraft when docking or performing other procedures requiring maneuvering of the aircraft.

In another embodiment of the present invention, the planar element 112 is buoyant in water (i.e., the amount of water displaced by the element 112 weighs more than the element 112) and may include a cavity that is filled with a gas, such as air, or a low density material such as foam or Styrofoam. The cavity may also be filled with air-filled enclosures. In another embodiment of the present invention, a top surface of the planar element 112 may comprise a substrate that is conducive for providing traction for walking. Examples of these substrates may be adhesive abrasive material used for non-skid applications, such as grip tape, adhesive rubber compound, or any other method for increasing the non-skid properties of the upper surface.

FIG. 6 also shows that the planar element 112 extends in front of and behind the opening 106 so as to provide a large area for a passenger to access the opening 106. Additionally, a large part of the planar element 112 is located in front of the fixed wing 114. This position of the platform portion 202 allows an individual to stand in an upright position in front of the fixed wing 114 (e.g., in order to get into or out of the opening 106 or maneuver the aircraft 100) without accidentally bumping into the fixed wing 114. Alternative embodiments may position the planar element 112 and/or the fixed wing 114 in other locations.

The combination of the planar elements 112, 202 and the ellipsoidal-shaped elements 204, 102 provides increased hydrodynamic handling performance of the hull 104. The ellipsoidal-shaped elements 204, 102 provide lateral stability and buoyancy at slow speeds as well as at hydroplaning speeds. These ellipsoidal-shaped elements 204, 102 also function to allow the seaplane (i.e., aircraft 100) to turn much more aggressively while hydroplaning than would be otherwise possible without the ellipsoidal-shaped elements 204, 102 or with normal sponsons mounted to the wing as in conventional hull-type seaplanes.

Additionally, the planar elements 112, 202 and the ellipsoidal-shaped elements 204, 102, or a combination of both may also provide a structural attachment and/or housing for landing gear (not shown). For example, one embodiment of the aircraft 100 may have a landing gear stored in the underside of the ellipsoidal-shaped elements 204, 102. In another example, a wheel of the landing gear may be stored in the ellipsoidal-shaped elements 204, 102 with remaining portions of the landing gear stored in the planar elements 112, 202.

The ellipsoidal-shaped elements 204, 102 may also function as a bumper for docking the aircraft 100 while on the water or rafting the aircraft to other water vehicles such as boats or personal watercrafts. According to one embodiment, an outer surface of the ellipsoidal-shaped elements 204, 102 may comprise rubber or a rubber-like substance to provide some cushioning against the dock or other vehicles

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An apparatus for an aircraft, comprising:
at least one member coupled to a fuselage of the aircraft, wherein the at least one member provides buoyancy in water and a planar element for allowing a passenger to stand on it.

2. The apparatus of claim 1, wherein the aircraft is a seaplane.

3. The apparatus of claim 2, wherein the fuselage comprises a hull that rests in water when the aircraft is landed.

4. The apparatus of claim 3, wherein the at least one member is shaped substantially like a sponson.

5. The apparatus of claim 4, wherein the at least one member is positioned underneath an opening in the aircraft.

6. The apparatus of claim 4, wherein the at least one member comprises two members, wherein each member is coupled to either side of the aircraft.

7. The apparatus of claim 6, wherein the at least one member comprises an airfoil cross-sectional shape.

8. A component for a hull-type seaplane, comprising:
a first sponson-shaped element that provides buoyancy in water; and
a first planar element coupled on one end with the first sponson-shaped element and coupled on another end to a hull on one side of the seaplane, wherein the first planar element allows a passenger to stand on it.

9. The component of claim 8, further comprising:
a second sponson-shaped element that provides buoyancy in water, and
a second planar element coupled on one end with the second sponson-shaped element and coupled on another end to the hull on another side of the seaplane, wherein the second planar element allows a passenger to stand on it.

10. The component of claim 9, wherein at least one planar element is positioned below an opening in the seaplane for allowing passengers to enter and exit the seaplane.

11. The component of claim 10, wherein the first and the second sponson-shaped elements comprise an airfoil cross-sectional shape.

12. The component of claim 10, further comprising landing gear positioned within an underside of the first and the second sponson-shaped elements.

13. The component of claim 10, wherein the at least one planar element is positioned in front of a fixed wing of the seaplane, such that a passenger may stand on the at least one planar element without being obstructed by the fixed wing.

14. The component of claim 10, further comprising a substrate disposed on top of at last one planar portion, wherein the substrate provides traction for passengers that may stand on it.

15. The component of claim 10, wherein the first and the second planar elements comprise an airfoil cross-sectional shape

16. A hull-type seaplane, comprising:
a hull that rests in water when the seaplane is landed;
a propeller engine;
a fixed wing;
a pair of sponsons, each sponson coupled to the hull on opposite sides of the seaplane, wherein each sponson includes:
a planar element coupled to the hull such that passengers may stand on it;
an elongated ellipsoid-shaped member coupled to one end of the planar element, wherein the ellipsoid-shaped member rests within water when the seaplane is landed.

17. The seaplane of claim 16, wherein at least one of the pair of sponsons is coupled to the hull underneath an opening in the seaplane for allowing passengers to enter and exit the seaplane.

18. The seaplane of claim 17, wherein each of the pair of sponsons provides buoyancy in water.

19. The seaplane of claim 18, wherein each of the pair of sponsons includes a cavity filled with a low density material including any one of foam, Styrofoam, or air-filled enclosures.

20. The seaplane of claim 18, wherein each of the pair of sponsons include an airfoil cross-sectional shape.
